(19) United States
(12) Patent Application Publication
(10) Pub. No.: US 2006/0153103 A1
(43) Pub. Date: Jul. 13, 2006

(54) Content reception device and content distribution method

(76) Inventor: Katsuhiro Sato, Aichi (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/559,780

(22) PCT Filed: May 28, 2004
(86) PCT No.: PCT/JP04/07788

§ 371 Date: Dec. 7, 2005

(30) Foreign Application Priority Data
Jun. 13, 2003 (JP) 2003-169165

(51) Int. Cl. H04J 3/22; H04Q 11/00; H04L 12/56; H04L 12/16; H04L 12/28; H04J 3/16

(52) U.S. Cl. 370/270; 370/465; 370/389

(57) ABSTRACT

A music reproduction apparatus (200) receives, from a tuning server (400), radio station information making up genres of music distributed from respective radio servers (300) and URLs of the respective radio servers (300). When a genre and a keyword representing characteristics of music are input to the music reproduction apparatus (200), the music reproduction apparatus (200) requests the radio server (300) distributing the music of the input genre to transmit the music information on the basis of the radio station information. The requested radio server (300) transmits one or more keywords to the music reproduction apparatus (200) as music information indicative of the characteristic of the music being broadcasted now. When the input keyword and the keyword included in the music information match with each other, the music reproduction apparatus (200) receives broadcast of the radio server (300) that has transmitted the music information.

### TECHNICAL FIELD

The present invention relates to contents distribution systems. More specifically, the present invention relates to a contents distribution system that selects a distribution site distributing contents of a desired genre from a plurality of distribution sites, and receives the contents distributed from the distribution site by a receiving apparatus.

### PRIOR ART

As such a kind of conventional contents distribution system, there is a system in which some broadcast programs are, in a streaming method, broadcasted from Internet radio stations (hereinafter referred simply to as “radio station”) each existing on the Internet, and receive it by personal computers or dedicated-terminals. Such the system is generally called Internet radio.

However, in such the conventional Internet radio, it is possible to previously know outlines of the contents of the programs to be broadcasted from the radio stations by information magazines, etc., but the knowable information is significantly limited in amount. Specifically, in a case that the information broadcasted from the radio station is music, it is possible to know what genre of music the radio station broadcasts, but it is impossible to know which station currently broadcasts cheering music or relaxing music when wanting to listen to cheering music due to emotional depression, or when wanting to listen to relaxing music due to accumulated stress, for example. That is, it is impossible to know the characteristics of the contents (music, etc.) to be broadcasted in detail.

One example of the Internet radio that it is possible to know in detail contents of the program to be broadcasted is disclosed in Japanese Patent Laying-open No. 2002-82959 [G06F 17/30]. In the prior art, the broadcast contents searching server inquires each of a plurality of radio servers existing on the Internet to make up the contents of the programs to be broadcasted from respective radio stations. Then, a program (radio station) to be received is selected on the basis of the made-up result.

However, in the prior art, complication occurs because the broadcast contents searching server has to frequently inquire about the search (making-up) with respect to each of a large number of radio stations, assuming that programs to be broadcasted by the respective of radio stations are updated. In addition, in the prior art, in a case that the information to be broadcasted is music, there is a problem of being known to the artist name and the music name relating to the music, but unknown to the characteristics (tone) of the music such as cheering, relaxing kinds, etc.

### SUMMARY OF THE INVENTION

Therefore, it is a primary object of the present invention to provide a novel contents receiving apparatus and contents distribution method.

Another object of the present invention is to provide a contents receiving apparatus and a contents distribution method capable of easily receiving contents (music, etc.) having a desired characteristic from a radio server (radio station).

The present invention is a contents receiving apparatus comprising a first requesting means for requesting a management site which manages genres of contents to be distributed from each of a plurality of distribution sites to transmit genre information allowing recognition of the genre, a first accepting means for accepting selection of an arbitrary genre, a specifying means for specifying any one of the plurality of distribution sites on the basis of the genre information transmitted in response to the request by the first requesting means and the genre accepted by the first accepting means, a second requesting means for requesting the distribution site specified by the specifying means to transmit a content, and a receiving means for receiving the content from the specified distribution site in response to the request from the second requesting means.

Furthermore, this invention is a contents distribution method for distributing a desired content to a terminal by utilizing a plurality of distribution sites which distribute contents different from each other and a management site which manages genres of the contents distributed from each of the plurality of distribution sites, wherein the management site (a1) reads genre information allowing recognition of the genre from a memory in response to a genre information request received from the terminal, and (b1) transmits the genre information read in the step (a1) to the terminal through a communication circuit. The terminal (a2) transmits the genre information request to the management site through the communication circuit, (b2) stores in a memory the genre information received from the management site in response to the genre information request transmitted in the step (a2), (c2) accepts selection of an arbitrary genre, (d2) specifies any one of the plurality of distribution sites on the basis of the genre information stored in the memory and the genre accepted in the step (c2), (e2) transmits a distribution request to the specified distribution site specified in the step (d2) through the communication circuit, and (f2) stores in the memory the content received from the specified distribution site in response to the distribution request transmitted in the step (e2). Each of the plurality of distribution sites (a3) reads content from a memory in response to the distribution request received from the terminal, and (b3) transmits the content read in the step (a3) to the terminal through the communication circuit.

In this invention, on the basis of the operation by the user, the first requesting means requests the management site which manages the genres of contents to be distributed from each of the plurality of distribution sites to transmit the genre information allowing recognition of the genres. When the user selects and inputs a genre, the first accepting means accepts it. The specifying means specifies any one of the plurality of distribution sites on the basis of the genre information transmitted from the management site in response to the request by the first requesting means and the genre accepted by the first accepting means. The second requesting means requests the specified distribution site specified by the specifying means to transmit the content, and the receiving means receives the content to be distributed from the specified distribution site in response to the request by the second requesting means.

Furthermore, in this invention, a distribution site for receiving content distribution is specified on the basis of genres and keywords. That is, a second accepting means accepts the keyword input by the user. A first distribution site specifying means specifies a distribution site distributing the content of the genre accepted by the first accepting means. A text information requesting means requests the distribution site specified by the first distribution site specifying means to transmit text information relating to the content being distributed now. Then, the second distribution site specifying means specifies one distribution site on the basis of the text information and the keyword.

According to this invention, a distribution site for receiving content distribution is determined on the basis of the characteristics information of the content being distributed. Thus, it is possible to accept distribution of the content having desired characteristics.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an illustrative view showing an entire configuration of one embodiment of the present invention.

FIG. 2 is a block diagram showing a schematic configuration of a music reproduction apparatus in FIG. 1.

FIG. 3 is a block diagram showing a schematic configuration of a radio server in FIG. 1.

FIG. 4 is a block diagram showing a schematic configuration of a tuning server in FIG. 1.

FIG. 5 is an illustrative view showing a flow of operation of an entire system when the music reproduction apparatus receives radio broadcast in FIG. 1 embodiment.

FIG. 6 is an illustrative view showing a schematic configuration of music information to be transmitted from the radio server to the music reproduction apparatus in FIG. 1 embodiment.

FIG. 7 is an illustrative view showing a display example of radio station information to be transmitted from the tuning server to the music reproduction apparatus in FIG. 1 embodiment.

FIG. 8 is an illustrative view showing one example of a display of a liquid crystal display of the music reproduction apparatus in FIG. 1 embodiment.

FIG. 9 is an illustrative view showing one example of a display of the liquid crystal display of the music reproduction apparatus in FIG. 1 embodiment.

FIG. 10 is an illustrative view showing one example of a display of the liquid crystal display of the music reproduction apparatus in FIG. 1 embodiment.

FIG. 11 an illustrative view showing one example of a display of the liquid crystal display of the music reproduction apparatus in FIG. 1 embodiment.

FIG. 12 is a flowchart showing an operation of a main CPU when the music reproduction apparatus receives music in FIG. 1 embodiment.

FIG. 13 is a flowchart continued from FIG. 10.

FIG. 14 is a flowchart continued from FIG. 10.

FIG. 15 is a flowchart showing an operation of a CPU of the tuning server in FIG. 1 embodiment.

FIG. 16 is a flowchart showing an operation of a CPU of the radio server in FIG. 1 embodiment.

### BEST MODE FOR PRACTICING THE INVENTION

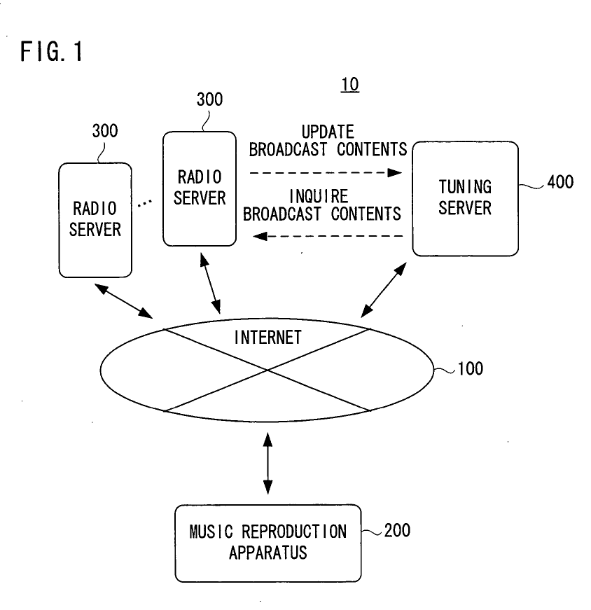

Referring to FIG. 1, a music distribution system 10 of the embodiment includes a music reproduction apparatus 200 to be connected to the Internet 100, radio servers 300 for providing programs like radio broadcast via the Internet 100, and a tuning server 400 for providing to the music reproduction apparatus 200 information of presence of each of the radio servers 300 existing on the Internet 100 through the search of the Internet 100.

The music reproduction apparatus 200 is an apparatus intended for home use, and has a function, as so-called an Internet radio receiver, of receiving programs provided from the radio servers 300. It is noted that each of the radio servers 300 broadcasts music contents in this embodiment.

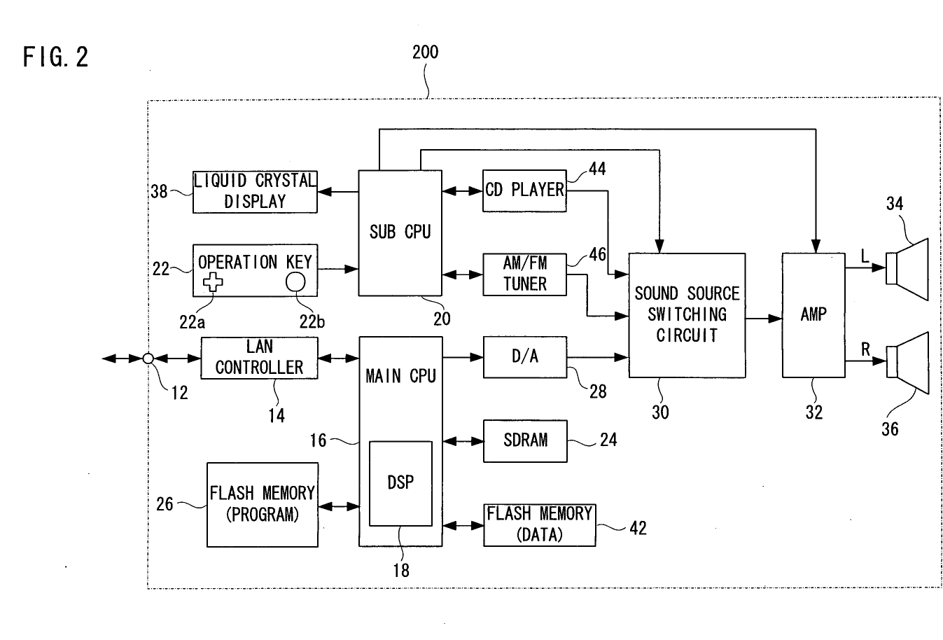

The music reproduction apparatus 200 specifically has a communication connector 12 which is a physical connecting port to the Internet 100 as shown in FIG. 2. That is, this communication connector 12 is connected to a not-shown modem (ADSL (Asymmetric Digital Subscriber Line) modem, for example) via a LAN (Local Area Network) cable not shown, and in turn connected to a telephone line. Within the music reproduction apparatus 200 on the other hand, the communication connector 12 is connected to a main CPU (Central Processing Unit) 16 via a LAN controller 14 for an Ethernet (registered trademark). It is noted that the main CPU 16 is formed integrally with a DSP (Digital Signal Processor) 18 described later by an ASIC (Application Specified IC). In addition, in the music reproduction apparatus 200, there is provided with a sub CPU 20 for man-machine interface control separately from the main CPU.

When an operation of accessing a radio server 300 of an arbitrary broadcast station 300, that is, a tuning operation is performed by an operation key 22 (cross key 22a and determination key 22b), although detailed description will be described later, data for tuning is applied from the tuning server 400, the sub CPU 20 informs the main CPU 16 of a content of the operation. The main CPU 16 generates a packet signal to issue an access request to the radio server 300 according to the TCP/IP (Transmission Control Protocol/Internet Protocol) on the basis of the notification from the sub CPU 20. The generated packet signal is sent onto the Internet 100 via the LAN controller 14 and the communication connector 12, and distributed to the radio server 300 via a predetermined route.

The radio server 300 receives the above-described packet signal to verify the access request from the music reproduction apparatus 200. Then, in response to the access request, streaming data indicative of the content of the program is transmitted to the music reproduction apparatus 200.

Packet signals transferred from the radio server 300 to the music reproduction apparatus 200 are sequentially input to the main CPU 16 via the communication connector 12 and the LAN controller 14. The main CPU 16 extracts the above-described streaming data from the input packet signals, and temporarily stores the fetched streaming data in an SDRAM (Synchronous Dynamic RAM) 24 as a main memory. Then, the streaming data stored in the SDRAM 24 are transmitted to the DSP 18.

The streaming data transmitted to the DSP 18 is data compressed according to the WMA (Windows Media Audio: Windows=registered trademark) format. The DSP 18 decodes the compressed streaming data into PCM (Pulse Coded Modulation) data before compression. The decode program for decoding the data thus compressed in the WMA format is stored in the flash memory 26. Also, the decode program for decoding data compressed in the MP3 (MPEG-1/Audio Layer 3) format is also stored in the flash memory 26. That is, the DSP 18 is compatible with two audio compression formats including the WMA format and the MP3 format.

The PCM data reproduced by the DSP 18 is input to a D/A converter 28 so as to be converted to a sound signal being an analog electric signal here. The converted sound signal is input to an amplifier 32 via a sound source switching circuit 30 so as to be subjected to an amplifying process here, and then input to the right and left speakers 34 and 36. This allows a sound of the program to be output from the respective speakers 34 and 36 in real time.

It is noted that the music reproduction apparatus 200 is also provided with a CD (Compact Disc) player 44 and an AM/FM tuner 46. Then, through the manipulation of the operation key 22, music can be reproduced regarding any one of the CD player 44 and the AM/FM tuner 46 as a sound source.

Describing in detail, when an operation indicating that either of the CD player 44 and the AM/FM tuner 46 is regarded as a sound source is carried out by the operation key 22, the sub CPU 20 controls the sound source switching circuit 30 such that an analog sound signal to be output from either of the sound source sides is input to the amplifier circuit 32. This allows the music to be output from the speakers 34 and 36, regarding either of the CD player 44 and the AM/FM tuner 46 as the sound source.

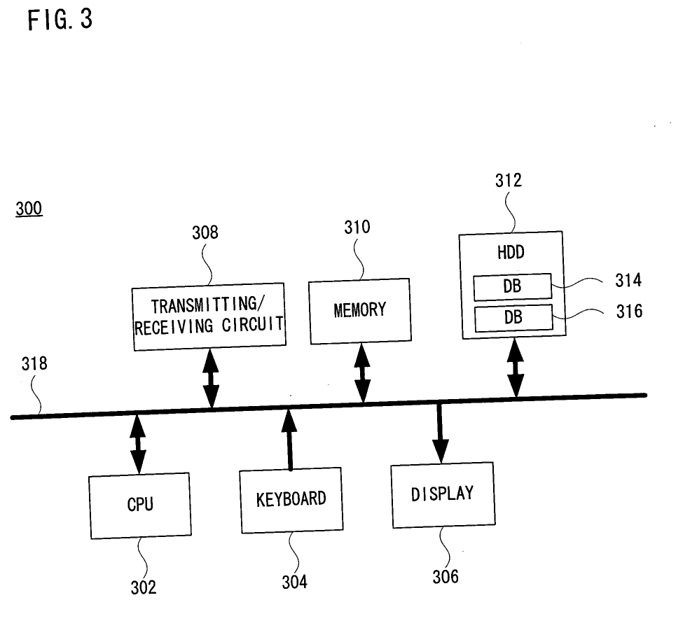

On the other hand, the radio server 300 is constructed as shown in FIG. 3. That is, a bus 318 is connected with a keyboard 304, a display 306, a transmitting/receiving circuit 308, a memory 310, and an HDD (Hard Disc Drive) 312 as well as a CPU 302. The HDD 312 is formed with a DB (Data Base) 314 storing music information to be described later and a DB 316 storing program data (music data, etc.) to be broadcasted. Then, on receipt of a request from the music reproduction apparatus 200, the music information or the program data collected in the DB 314 is sent to the transmitting/receiving circuit 308 via the Internet 100 to be sent to the music reproduction apparatus 200.

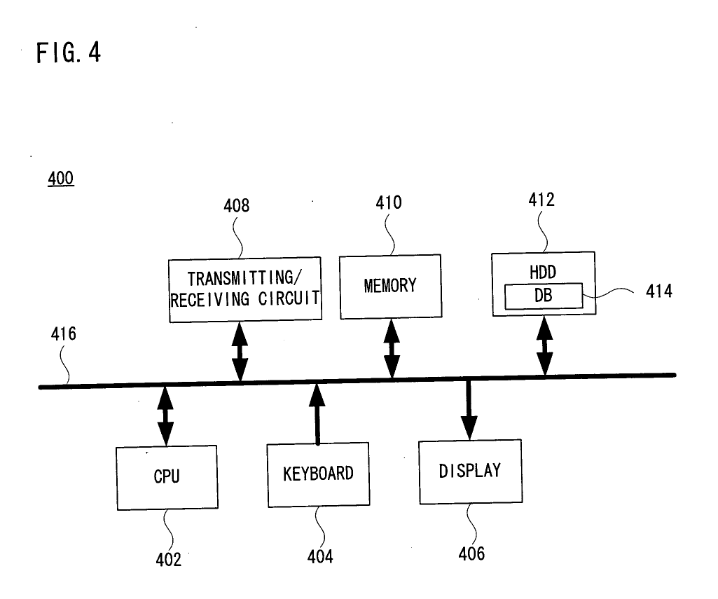

In addition, the tuning server 400 is constructed as shown in FIG. 4. As understood from FIG. 3 and FIG. 4, the tuning server 400 is constructed similar to the radio server 300. That is, a bus 416 is connected with a keyboard 404, a display 406, a transmitting/receiving circuit 408, a memory 410, and an HDD 412 as well as a CPU 402. The HDD 412 is formed with a DB 414 storing radio station information including genres of music to be broadcasted by respective radio servers 300 and URLs (Uniform Resource Locator) for connecting with the respective radio servers 300. Then, on receipt of a request from the music reproduction apparatus 200, the radio station information collected in the DB 414 is sent to the Internet 100 via the transmitting/receiving circuit 408, and in turn sent to the music reproduction apparatus 200.

In the music distribution system 10 including such the music reproduction apparatus 200, the radio server 300 and the tuning server 400, it is possible to select a radio server 300 broadcasting a music the user want to listen to on the basis of the genre of music and the keyword. Here, the keyword is for representing characteristics of music such as “healing music”, “soft music”, “cheering music”, “lively music”, etc. Specifically, the user of the music reproduction apparatus 200 can listen to the “healing music” by selecting the radio server 300 from which the healing music is being broadcasted now when feeling a need to be healed due to accumulated stress, for example. Or, the user can listen to the “cheering music” by selecting the radio server 300 from which the “cheering music” is being broadcasted now when feeling a need to cheer up from emotional depression.

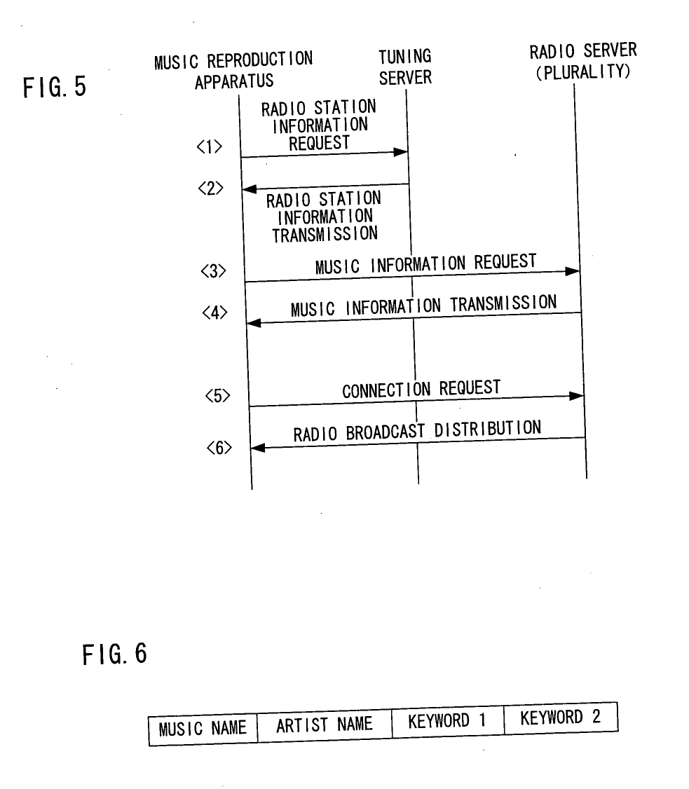

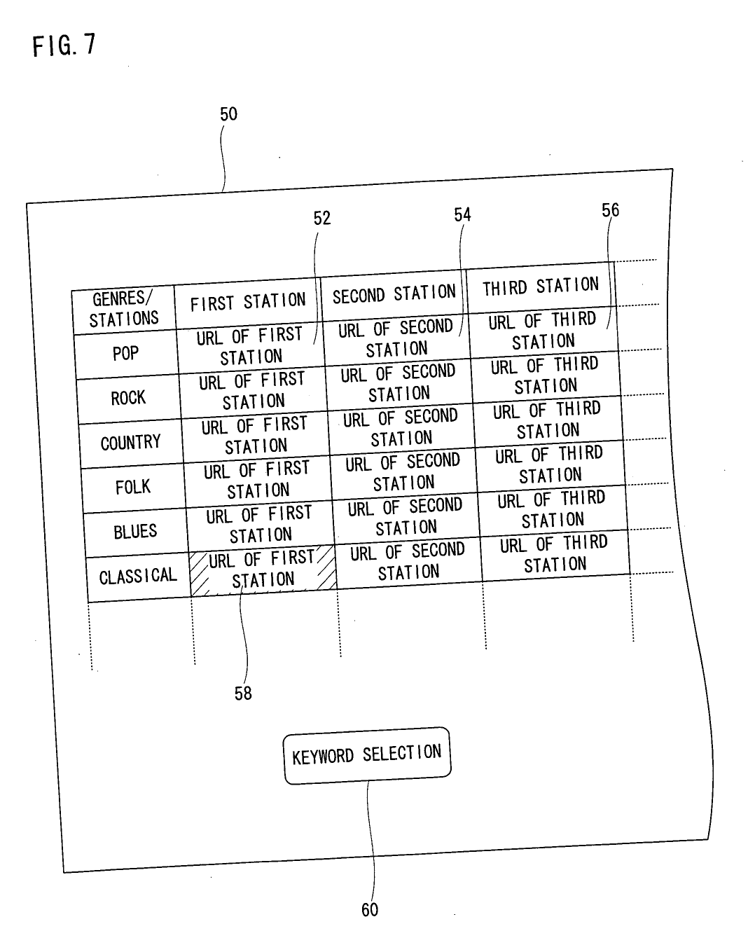

In a case of listening to music with the music reproduction apparatus 200, as shown in FIG. 5, a radio station information request is first sent from the music reproduction apparatus 200 to the tuning server 400 (<1>). Then, the radio station information shown in FIG. 7 is sent to the music reproduction apparatus 200 from the tuning server 400 (<2>). The radio station information is, as shown FIG. 1, obtained by the tuning server 400 previously inquiring of each of the radio servers 300 the broadcast contents and making up them. However, the content of the radio station information is URL of the respective radio servers 300 and genre of the music to be broadcasted as understood from FIG. 7, and never changed frequently. Thus, the inquiry about the broadcast contents with respect to the respective radio servers 300 may simply periodically be made.

Next, the user selects and enters a genre and a keyword of a desired music to the music reproduction apparatus 200 with the operation key 22. Then, with respect to a radio server 300 indicating the URL of a first station of the selected genre, a music information request of the music currently being broadcasted by the radio server 300 is transmitted (<3>). The radio server 300 that has received the music information request transmits the music information shown in FIG. 6 to the music reproduction apparatus 200 (<4>).

As shown in FIG. 6, the music information includes a music name, an artist name, and a keyword of the music being broadcasted now. It is noted that the keyword is not limited in number and a plurality of keywords may be available, and one music information includes one or more keywords. In the music reproduction apparatus 200, it is determined whether or not the input keyword is included in the received music information. When the input keyword and the keyword included in the music information do not much, the music reproduction apparatus 200 transmits a music information request to a radio server 300 indicated by the URL of a second station of the selected genre (<3>). Then, music information is received from the second radio server 300 (<4>). Thus, the operations of <3> and <4> are repeated until the selected keyword and the keyword included in the music information become coincident to each other.

Then, matching the keywords means that the radio server 300 which has transmitted the music information broadcasts the music the user of the music reproduction apparatus 200 wants to listen to, and therefore, a connection request is made with respect to the radio server 300 indicated by the URL (<5>). The radio server 300 which receives the connection request distributes a radio program to the music reproduction apparatus 200 which has transmitted the connection request (<6>).

This allows the user of the music reproduction apparatus 200 to listen to the music having the desired characteristic.

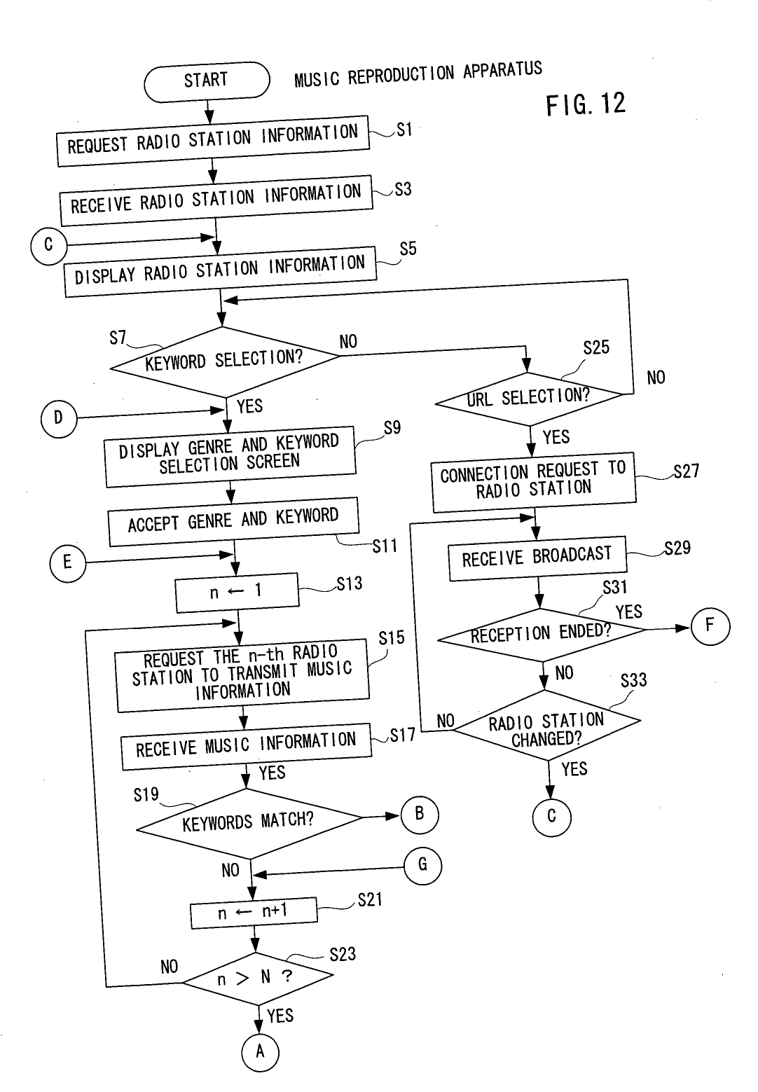

Using FIG. 7 to FIG. 16, a description is made on the operation of the music reproduction apparatus 200, the radio server 300, and the tuning server 400 below. First, a user of the music reproduction apparatus 200 (hereinafter simply referred to “user”) performs a radio station information request by operating the cross key 22a and the determination key 22b included in the operation key 22 on the basis of the display (not illustrated) of the liquid crystal display 38 provided on the music reproduction apparatus 200. Then, the main CPU 16 performs the radio station information request on the tuning server 400 in a step S1 in FIG. 12.

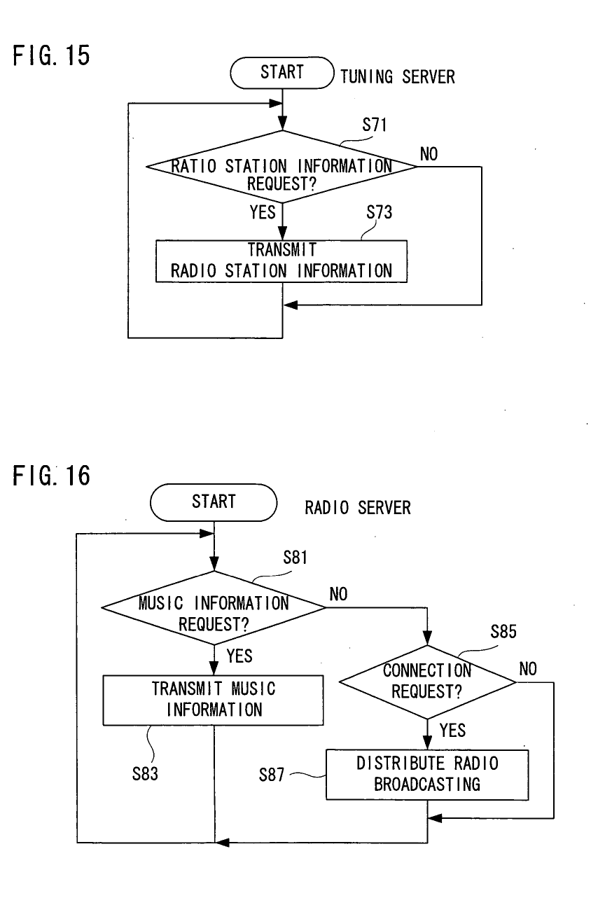

The tuning server 400 searches the radio servers 300 broadcasting music on the Internet 100, and classifies them for each genre to be broadcasted and holds them as a database (radio station information). Then, in response to the transmission of the radio station information request from the music reproduction apparatus 200, the CPU 402 of the tuning server 400 determines that the request of the radio station information is present in a step S71 in FIG. 15, and then transmits the radio station information collected in the DB 414 to the music reproduction apparatus 200 in a step S73.

The main CPU 16 receives the radio station information thus transmitted in a step S3, and displays a screen 50 representing the radio station information on the liquid crystal display 38 as shown in FIG. 7 in a step S5. The radio station information is displayed such that the radio servers 300 broadcasting the genre of the music are represented in a manner indicating URLs (52, 54, 56, etc. in FIG. 7) for each genres of music. Some appliances internally hold URLs, and displays radio station names on a display portion in selection. In addition, on the liquid crystal display 38, a “keyword selection button 60” is displayed as well as the radio station information.

When the user operates the cross key 22a, a cursor 58 (shaded region) is displayed on the liquid crystal display 38. Then, the user can select a radio station (URL of radio server 300) by inputting up and down and right and left directions with the cross key 22a to move the cursor 58, and by operating the determination key 22b with a cursor 510 put on an arbitrary URL. In a case that the radio server 300 is thus directly selected, it is possible to receive a program (music) broadcasted by the selected radio servers 300 similar to conventional Internet radios.

Before directly selecting the radio server 300, the cross key 22a is continuously downwardly input to move the cursor 58 to the “keyword selection button 60”. When the determination key 22b is operated in this state, music selection (also tuning) using keywords as an object of the present invention can be conducted.

When the URL is directly selected on the display screen in FIG. 7, the main CPU 16 determines the URL is selected in a step S25 in FIG. 12, and performs a connection request with respect to the radio server 300 indicated by the URL on the basis of the URL in a step S27.

When the connection request is transmitted from the music reproduction apparatus 200, the CPU 302 of the radio server 300 determines that the connection request is present in a step S85 in FIG. 16, and distributes (broadcasts) the program data (music data) collected in the DB 316 to the music reproduction apparatus 200 in a step S87.

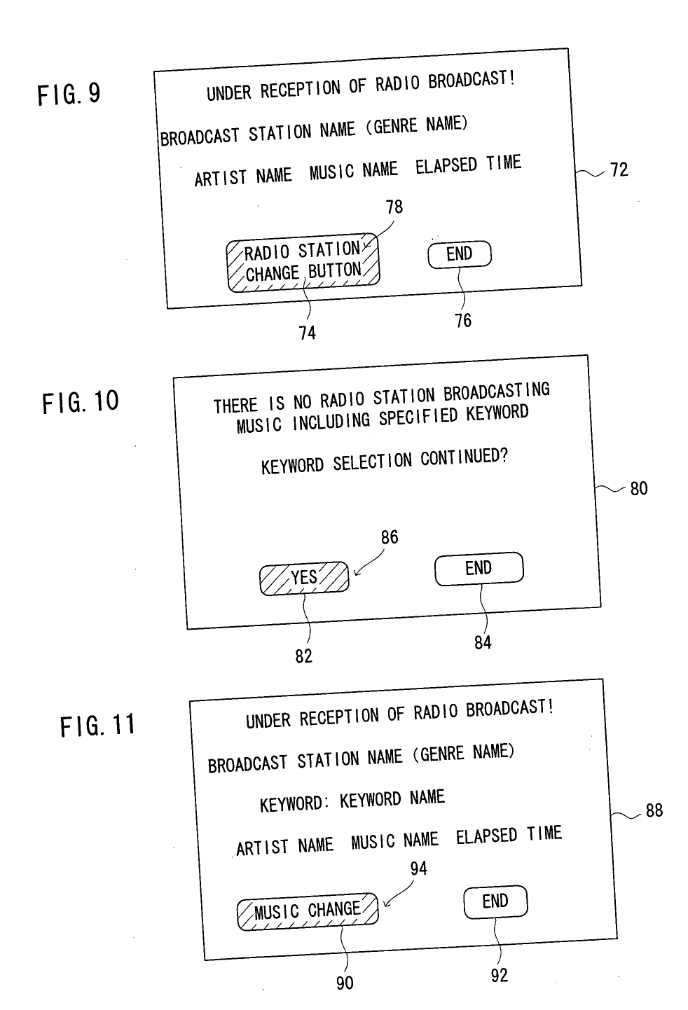

Then, the music reproduction apparatus 200 starts to receive the broadcast from the radio server 300 in a step S29 in FIG. 12. At this time, the liquid crystal display 38 displays a screen 72 shown in FIG. 9. As shown in FIG. 9, on the screen 72, a message indicative of being under reception of the radio broadcast, a broadcast station name, a genre name of music being broadcasted, an artist name of the music, a music name and an elapsed time from the start of the music are displayed, and a “radio station change button 74” and an “end button 76” are also displayed. At this time, a cursor 78 is put on the “radio station change button 74” at the default setting, and can be moved to the “end button 76” by operating the cross key 22a.

In a step S31, it is determined whether or not the reception of the radio broadcast is ended. If the user selects the “end button 76” in the step S31, the process of music reception is directly ended. On the other hand, if it is determined not to be ended in the step S31, it is determined whether or not the user selects the “radio station change button 74” in a step S33. If the “radio station change button 74” is not selected, the process returns to the step S29 to continue to receive the broadcast. On the other hand, if the “radio station change button 74” is selected, the process returns to the step S5 to display the radio station information shown in FIG. 7 on the liquid crystal display 38 once again.

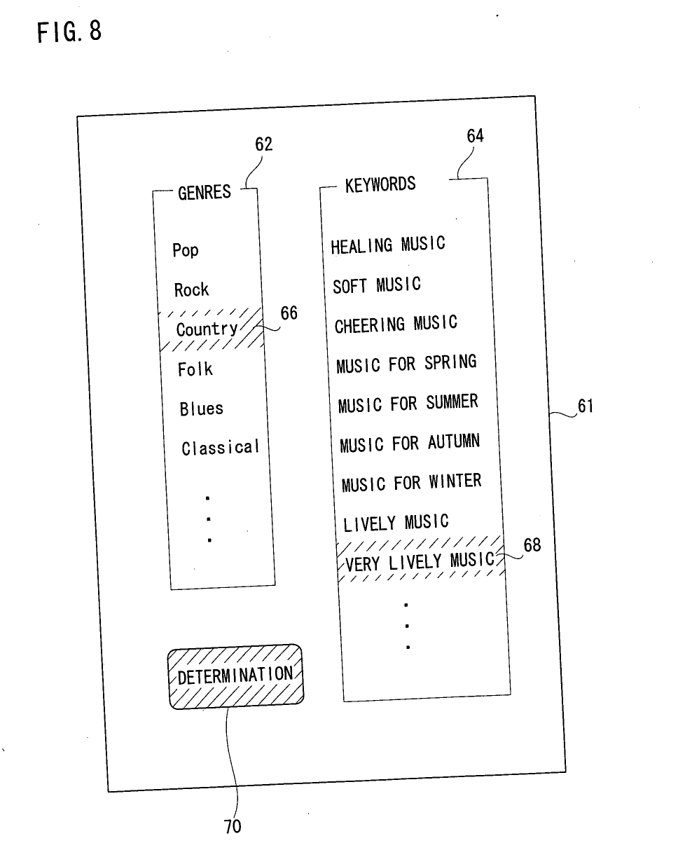

When the user selects the “keyword selection button 60” on the screen 50 shown in FIG. 7 displayed on the liquid crystal display 38 in the step S5, the main CPU 16 determines to be the keyword selection in a step S7, and displays a screen 61 shown in FIG. 8 on the liquid crystal display 38 in a step S9. As shown in FIG. 8, the screen 61 has a genre selection portion 62, a keyword selection portion 64, and a “determination button 70”.

A cursor 66 is displayed on the genre selection portion 62 at first, so that the user selects the genre of the music by moving the cursor 66 according to upward and downward inputs with the cross key 22a. Then, the determination key 22b is operated to determine the genre to be selected, and then, a cursor 68 is displayed on the keyword selection portion 64. The user makes upward and downward inputs with the cross key 22a, and then determines one keyword by operating the determination key 22b. In FIG. 8 example, the “Country” is selected as a genre, and the “very lively music” is selected as a keyword.

After determining the keyword, the cursor is displayed on the “determination button 70”, and in response to the operation of the determination key 22b, the main CPU 16 accepts the genre and keyword of the determined music in a step S111.

In a step S13, “1” is stored in a work area n. The work area n is for counting the radio server 300 of the selected genre.

In a step S15, the music information is requested to the n-th radio server 300 of the genre accepted in the step S11. Here, n of the n-th is a numerical value stored in the work area n, and the n-th means the order of display of the radio station information shown in FIG. 7. In addition, the radio server 300 broadcasting the music of the genre shall be N in number.

When the music information request is made from the music reproduction apparatus 200, in the radio server 300, the CPU 302 determines that the music information request is made in a step S81 in FIG. 16. Then, in a step S83, the music data of the music being broadcasted now and stored in the DB 314 is sent to the music reproduction apparatus 200.

The music reproduction apparatus 200 receives the music information sent from the radio server 300 in a step S17 in FIG. 12. The music information, as shown in FIG. 6, includes a music name, an artist name, and one or more keywords. The keyword included in the music information is the same as any one of the keywords shown in the keyword selection portion 64 in FIG. 8.

In a step S19, it is determined whether or not there is a keyword matching with the keyword accepted in the step S11, that is, selected by the user of the music reproduction apparatus 200 is present among the received music information. When the keyword matching with the keyword selected by the user is included in the music information, this means that the radio server 300 that has transmitted the music information is currently broadcasting the music with the characteristics desired by the user (“healing”, “cheering”, etc.).

In the step S19, when it is determined that the keywords do not match, this means that the radio server 300 is not broadcasting the music having the characteristic desired by the user. Accordingly, the process proceeds to a step S21 to increment the numerical value stored in the work area n by 1, and it is determined whether or not the numerical value n stored in the work area n is larger than the numerical value N in a step S23. The fact that numerical value n stored in the work area n is larger than the numerical value N means that no radio server 300 that is broadcasting the music of the genre selected by the user is present any more. The fact that the numerical value n stored in the work area n is equal to or smaller than the numerical value N means that another radio server 300 that is broadcasting the music of the genre selected by the user is present.

In the step S23, when it is determined that the numerical value n stored in the work area n is not larger than the numerical value N, the process returns to the step S15 to performs a music information request to a n-th (second) radio server 300.

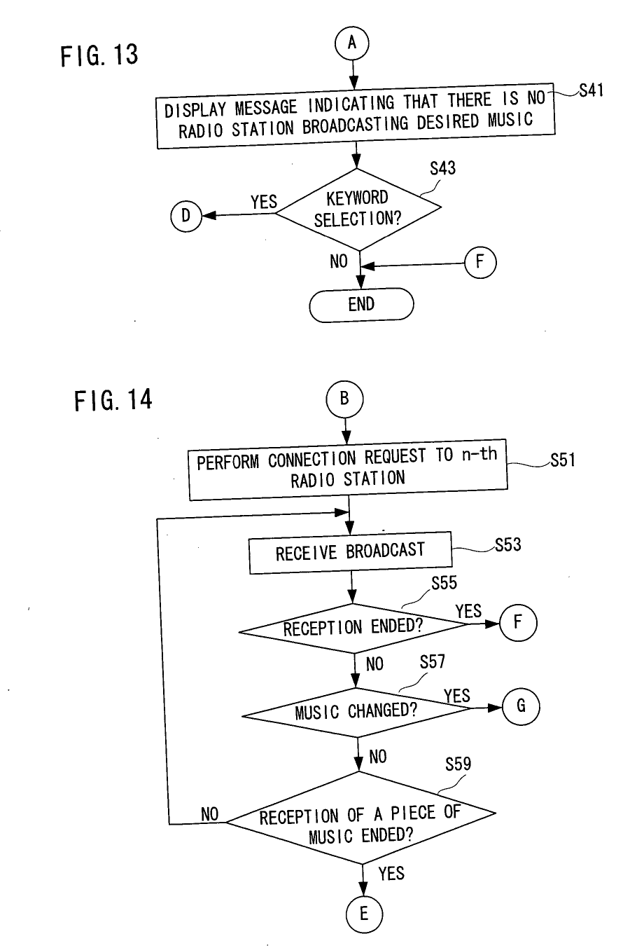

On the other hand, when it is determined that the numerical value n stored in the work area n is larger than the numerical value N in the step S23, a screen 80 shown in FIG. 10 indicating that no radio server 300 that is broadcasting the music having the characteristic desired by the user is present is displayed on the liquid crystal display 38 in a step S41 in FIG. 13. As shown in FIG. 10, on the screen 80, a question as to whether or not the keyword selection is continued is displayed, and the user can select either of “yes button 82” and “end button 84” by operating the cursor 86 with the operation key 22.

When the user selects the “yes button 82”, it is determined to be the keyword selection in a step S43, and the process returns to the step S9 in FIG. 12 to display the genre and keyword selection screen 61 on the liquid crystal display 38 shown in FIG. 8. On the other hand, when the user selects the “end button 84”, it is determined no to be the keyword selection in a step S43, and the music receiving process is ended.

In a case that it is determined that the keyword selected by the user and the keyword included in the received music information match with each other in the step S19 in FIG. 12, this means that the radio server 300 that has transmitted the music information is broadcasting the music having the characteristic desired by the user, the process proceeds to a step S51 and the following in FIG. 14 to performs reception of the music.

In the step S51, a connection request is performed with respect to the radio server 300 that is broadcasting a desired music on the basis of the URL of the n-th radio server 300.

When the connection request is transmitted from the music reproduction apparatus 200, the CPU 302 of the radio server 300 determines to be the connection request in a step S85 in FIG. 16, and distributes (broadcasts) the program data (music data) stored in the DB 316 to the music reproduction apparatus 200 in a step S87.

Then, the music reproduction apparatus 200 starts to receive the broadcast from the radio server 300 in a step S53 in FIG. 14. At this time, a screen 88 as shown in FIG. 11 is displayed on the liquid crystal display 38. As shown in FIG. 11, a message indicative of being under reception of the radio broadcast, a broadcast station name, a genre name of music being broadcasted, a keyword utilized on selection, an artist name of the music, a music name, and a elapsed time from the start of the music are displayed on the screen 88, and a “music change button 90” and an “end button 92” are also displayed. At this time, a cursor 94 is put on the “music change button 90” at the default setting, and can be moved to the “end button 92” by operating the cross key 22a.

In a step S55, it is determined whether or not the reception of the radio broadcast is ended. When the user selects the “end button 92” in the step S55, the process directly ends the music receiving process. On the other hand, when it is determined that the process is not ended in the step S55, it is determined whether or not the user selects the “music change button 90” in a step S57. The time when the user selects the “music change button 90” is a case where he or she stops listening to the music distributed from the currently connected radio server 300, and wants to listen to another music distributed from another radio servers 300.

If it is determined to be the change of the music in the step S57, the process returns to the step S21 in FIG. 12 to increment the numerical value stored in the work area n by one (1). Then, the process in the above-described step S23 and the following is executed to perform searches whether or not the next (n-th) radio server 300 broadcasts music of the genre designated by the user and with the characteristic designated by the keyword. Through the repetition of the search, the user can listen to the music of a desired genre and a desired characteristic (defined by the keyword) that is broadcasted from a radio server 300 different from the previous server.

On the other hand, when it is determined to be not the change of the music in the step S57, it is determined whether or not broadcast of a piece of music is completed in a step S59. Whether or not broadcast of the music is completed can be made on the basis of the elapsed time of the broadcast of the music. When it is determined that the broadcast of the music is not completed, the process returns to the step S53 to continue to receive broadcast. On the other hand, when it is determined that the broadcast of the music completed, the process returns to the step S13 in FIG. 12 to make initialization by storing a numerical value 1 in the work area n. Initialization of the work area n allows the user to confirm whether or not the music having a desired characteristic is broadcasted from the first radio server 300 again.

As understood from the above description, in the music distribution system 10 of this embodiment, by designating the keyword indicating the characteristic of the genre and the music (“healing music” and “cheering music”, etc.) desired by the user, the user can easily listen to the music at his discretion, feeling high satisfaction.

It is noted that although the tuning server 400 is one in this embodiment for the sake of simplicity, a plurality of tuning servers may be available.

Furthermore, a connection to the Internet 100 by the music reproduction apparatus 200, is not limited to wireline means, may be wireless means.

Also, although the keywords indicative of the characteristic of the music are selected from an at-a-glance chart, the user can input it at his or her pleasure.

In addition, although a description is made on auditory contents in this embodiment, the invention is applicable to visual contents such as a case of dealing with moving images.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A contents receiving apparatus, comprising:
a first requesting means for requesting a management site which manages genres of contents to be distributed from each of a plurality of distribution sites to transmit genre information allowing recognition of said genre,
a first accepting means for accepting selection of an arbitrary genre,
a specifying means for specifying any one of said plurality of distribution sites on the basis of the genre information transmitted in response to the request by said first requesting means and the genre accepted by said first accepting means,
a second requesting means for requesting the distribution site specified by said specifying means to transmit a content, and
a receiving means for receiving said content from said specified distribution site in response to the request from said second requesting means.

2. A contents receiving apparatus according to claim 1, further comprising
a second accepting means for accepting an arbitrary keyword,
said specifying means includes a first distribution site specifying means for specifying a distribution site distributing the content of the genre accepted by said first accepting means, a text information requesting means for requesting the distribution site specified by said first distribution site specifying means to transmit text information relating to the content being distributed at this point, and a second distribution site specifying means for specifying one distribution site on the basis of the text information transmitted in response to the request by said text information requesting means and the keyword accepted by said second accepting means.

3. A contents receiving apparatus according to claim 2, wherein said content is music, and said text information is information describing a tone of said music.

4. A contents receiving program to be executed by a processor provided in a contents receiving apparatus, said contents receiving program including:
a first requesting step for requesting a management site which manages genres of contents to be distributed from each of a plurality of distribution sites to transmit genre information allowing recognition of said genre,
a accepting step for accepting selection of an arbitrary genre,
a specifying step for specifying any one of said plurality of distribution sites on the basis of the genre information transmitted in response to the request by said first requesting step and the genre accepted by said first accepting step,
a second requesting step for requesting the specified distribution site specified by said contents specifying step to transmit a content, and
a receiving step for receiving said content from said specified distribution site in response to the request from said second requesting step.

5. A contents distribution method for distributing a desired content to a terminal by utilizing a plurality of distribution sites which distribute contents different from each other and a management site which manages genres of the contents distributed from each of said plurality of distribution sites, wherein
said management site
(a1) reading genre information allowing recognition of said genre from a memory in response to a genre information request received from said terminal, and
(b1) transmitting said genre information read in said step (a1) to said terminal through a communication circuit,
said terminal
(a2) transmitting said genre information request to said management site through said communication circuit,
(b2) storing in a memory said genre information received from said management site in response to said genre information request transmitted in said step (a2),
(c2) accepting selection of an arbitrary genre,
(d2) specifying any one of said plurality of distribution sites on the basis of said genre information stored in said memory and said genre accepted in said step (c2),
(e2) transmitting a distribution request to the specified distribution site specified in said step (d2) through said communication circuit, and
(f2) storing in the memory a content received from said specified distribution site in response to said distribution request transmitted in said step (e2),
each of said plurality of distribution sites
(a3) reading the content from a memory in response to said distribution request received from said terminal, and
(b3) transmitting said content read in said step (a3) to said terminal through said communication circuit.
